(19) United States
(12) Patent Application Publication
(10) Pub. No.: US 2024/0176938 A1
(43) Pub. Date: May 30, 2024

(54) METHOD FOR PREPARING AND PROVIDING AN FPGA BUILD RESULT OF AN FPGA MODEL

(71) Applicant: dSPACE GmbH, Paderborn (DE)

(72) Inventors: Martin KRONMUELLER, Paderborn (DE); Dominik LUBELEY, Verl (DE); Frank PUSCHMANN, Paderborn (DE); Joerg HAGENDORF, Paderborn (DE)

(21) Appl. No.: 18/518,500

(22) Filed: Nov. 23, 2023

(30) Foreign Application Priority Data
Nov. 25, 2022 (EP) 22209730.5

(51) Int. Cl. G06F 30/34

(52) U.S. Cl. CPC G06F 30/34

(57) ABSTRACT

A method for preparing an FPGA build result of an FPGA model is provided. The method includes designating an FPGA subsystem to configure a set of FPGA functions of the FPGA model. A pre-scaling subsystem and a post-scaling subsystem of the FPGA model are designated for execution on a processor. Internal and external interfaces are designated in the pre-scaling subsystem and post-scaling subsystem, where the internal interfaces ensure a data flow within the FPGA model, and the external interfaces ensure a data flow away from the FPGA model. Overall FPGA functionality is generated and the FPGA build result is generated on the basis of the generated overall FPGA functionality, where the FPGA build result includes a single master container file. The FPGA build result is provided to a further application for determining a set of functions of an entire model that includes the FPGA model and a processor model.

### CROSS REFERENCE TO RELATED APPLICATIONS

This application claims benefit to European Patent Application No. EP 22209730.5, filed on Nov. 25, 2022, which is hereby incorporated by reference herein.

### FIELD

The invention relates to a method for preparing and providing a field programmable gate array (FPGA) build result of an FPGA model having at least one overall FPGA functionality.

### BACKGROUND

An FPGA is an integrated circuit within digital technology, into which a logic circuit can be loaded. In contrast with the programming of computers, microcontrollers, and controllers, in FPGAs the term “programming” or “FPGA build” means not only the specification of time sequences, but also the definition of the intended circuit structure. This circuit structure is formulated using a hardware description language and is then translated into a configuration file using software, which file specifies how the elements should be interconnected in the FPGA. When programming an FPGA, a description of the hardware structure is therefore generated, which is then transmitted to the FPGA itself using synthesis and routing tools.

This hardware description is typically provided in special languages, such as VHDL or Verilog. Instead of an “FPGA program,” reference is therefore also made to an “FPGA configuration” here. Unlike the programming of computers, microprocessors, and controllers, the FPGA programming is therefore not directed to a predetermined operating system and a driver basis; instead, the FPGA programming is geared toward defining structures in the semiconductor which later perform the intended functions. This can obtain a level of specialization and parallelity that is difficult to achieve with conventional prefabricated microprocessors.

In the field of hardware-in-the-loop simulation (HIL simulation) and in rapid control prototyping systems (RCP systems), real-time simulations, for example in the technical fields of power electronics and e-mobility, have not been able to be attained by processor models alone for some time. In many applications, such as simulations, in which very rapid control loops may be required, these need to be supplemented or even replaced with FPGA models. Such hardware for HIL simulations and in rapid control prototyping systems has a number of FPGAs for different sets of functions or circuit components, for example FPGAs for communication in a real-time network and FPGAs that can implement different sets of I/O functions on I/O channels.

By using abstracting FPGA development environments, users can also develop their own hardware without detailed knowledge of an FPGA and toolflows. In the field of rapid control prototyping (RCP), rapid control loops can be engineered on the FPGA and can be operated on a hardware board as a prototype controller, for example. As the demands on rapid control loops increase, for example in the e-Drive environment, in power electronics, or in engine control, increasingly powerful FPGAs may be required.

Generally speaking, a real-time application, for example for an e-Drive or power electronics HIL simulation, consists of a slow model section, the so-called behavior model, which runs on the processor, and a rapid model section, for example a rapid control loop having direct I/O coupling, which runs on the FPGA. In this case, the data exchange between the processor and the FPGA model takes place in particular via an FPGA register interface, buffer interface, or bus interface.

Users in FPGA modeling departments often prepare FPGA build results for reuse in processor modeling departments. In this case, real-time applications for HIL simulators result from a combination of an FPGA build result and the processor model.

The data transmitted and received by the FPGA often still have to be processed on the processor, since certain functions on the FPGA may require too many resources, for example. In this case, reference is made to pre-scaling and post-scaling, or pre-processing and post- processing.

This means that, conventionally, in addition to the FPGA build result, a passing result for an overall FPGA functionality additionally consists of a pre-processing and post-processing processor model section, which the user has to copy into each of their processor models in order to be able to interact correctly with the FPGA model. In this case, the models are partitioned between the FPGA and the processor. Once a section of the FPGA model has been moved to the processor, it is part of the processor model and is thus separate from the FPGA build result. This makes the sale of FPGA solutions and the exchange of FPGA build results complicated and error-prone for users.

### SUMMARY

In an embodiment, the present disclosure provides a method for preparing and providing an FPGA build result of an FPGA model having at least one overall FPGA functionality, wherein the at least one overall FPGA functionality comprises an FPGA subsystem, a pre-scaling subsystem, and a post-scaling subsystem. The method comprises a) designating the FPGA subsystem, wherein a set of FPGA functions of the FPGA model can be configured using the FPGA subsystem, b) designating the pre-scaling subsystem and the post- scaling subsystem of the FPGA model for execution on a processor, c) designating internal and external interfaces in the pre-scaling subsystem and post-scaling subsystem, wherein the internal interfaces ensure a first data flow within the FPGA model, and the external interfaces ensure a second data flow away from the FPGA model, d) generating the at least one overall FPGA functionality, e) generating the FPGA build result on the basis of the generated at least one overall FPGA functionality, wherein the FPGA build result includes a single master container file, f) providing the FPGA build result to a further application for determining a set of functions of an entire model that includes the FPGA model and a processor model.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a method for preparing and providing an FPGA build result according to a preferred exemplary embodiment of the invention;

FIG. 2 schematically shows an FPGA model according to a preferred exemplary embodiment of the invention;

FIG. 3a-3g show schematic example applications of a method for preparing and providing an FPGA build result according to a preferred exemplary embodiment of the invention; and

FIG. 4 schematically shows an entire system according to a preferred exemplary embodiment of the invention.

### DETAILED DESCRIPTION

In view of the background discussed above, aspects of the present invention provide a method for modeling an FPGA build result, which results in a standardized FPGA model; and thus, means that the FPGA build result can be reused in a reliable and simple manner.

According to embodiments of the invention, a method is provided for preparing and providing an FPGA build result of an FPGA model having at least one overall FPGA functionality, wherein the overall FPGA functionality comprises an FPGA subsystem, a pre- scaling subsystem, and a post-scaling subsystem, comprising the following method steps:
a) designating the FPGA subsystem, wherein the set of FPGA functions of an FPGA model can be configured using the FPGA subsystem,
b) designating the pre-scaling subsystem and the post-scaling subsystem of an FPGA model for execution on a processor,
c) designating internal and external interfaces in the pre-scaling subsystem and post- scaling subsystem, wherein the internal interfaces ensure a data flow within the FPGA model, and the external interfaces ensure a data flow away from the FPGA model,
d) generating the overall FPGA functionality,
e) generating the FPGA build result on the basis of the generated overall FPGA functionality, wherein the FPGA build result includes a single master container file,
f) providing the FPGA build result to a further application for determining a set of functions of an entire model that includes the FPGA model and the processor model.

In some embodiments of the invention, the overall FPGA functionality is modeled in the FPGA model in an interrelated manner. The pre-scaling subsystem and the post-scaling subsystem are marked together with the internal and external interfaces and are added to the overall FPGA functionality of the FPGA model. In this way, independently of the processor model, a standardized FPGA build result is generated which ensures that the FPGA build result can be reused for subsequent applications in a reliable and less error-prone manner. The subsequent applications can in particular be modeling of an entire system composed of the FPGA model and the processor model. Here, a processor model is understood to mean a processor behavior model that can be modeled by the user. The method according to the invention makes it possible to prepare an FPGA build result that functions in a reliable and simple manner with any user-specific processor models.

When an FPGA subsystem is discussed here, this means the blocks of the FPGA model that do not count among the scaling systems, but instead determine the set of functions of the FPGA. These can be encapsulated in a subsystem of the FPGA model, but do not have to be.

When a data flow within the FPGA model is discussed here, this in particular means a data flow between the scaling subsystems and the FPGA subsystem. A data flow away from the FPGA model in particular describes a data flow from the FPGA model to a processor model connectable to the FPGA model, or a data exchange between the FPGA model and a connectable processor model.

The subsystems are preferably designated in a GUI-assisted manner by marking data structures manually or via a graphical user interface.

According to an embodiment of the invention, generating the overall FPGA functionality comprises the following method step:
A) performing at least one consistency check of the pre-scaling subsystem and the post- scaling subsystem.

The consistency check is performed to eliminate any incorrect modeling. The consistency check preferably takes place in accordance with the following scheme:
Consistency check #1: FPGA setup block in the FPGA model
Consistency check #2: Properly configured subsystems
Consistency check #3: No scaling subsystem within another scaling subsystem
Consistency check #4: No FPGA function of one overall FPGA functionality in the subsystem of another overall FPGA functionality
Consistency check #5: Scaling subsystems may not be associated with different FPGA functions
Consistency check #6: Prevention of a plurality of scaling subsystems per overall FPGA functionality having identical register group IDs, since they may not be associated with different tasks
Consistency check #7: A plurality of scaling subsystems per overall FPGA functionality having different register group IDs, since they may be associated with different tasks

In this case, the FPGA section, in particular designated as an FPGA subsystem, of an overall FPGA functionality is preferably understood to be an FPGA function.

According to an embodiment of the invention, generating the overall FPGA functionality comprises the following method steps:
B) generating an FPGA bit stream for the FPGA subsystem,
C) generating one scaling processor code per scaling subsystem, and
D) including the FPGA bit stream and the scaling processor codes as a sub-container file in each case in the master container file of the FPGA build result.

In this case, according to an embodiment of the invention, the sub-container file of a scaling subsystem includes the scaling processor code, a data interface description, and/or makefiles.

The overall FPGA functionality is preferably automatically generated in this case. In the present case, “automatically” is understood to mean the automatic sequence of a plurality of method steps once this automatic action is activated. Therefore, the user is provided with a one-click build for the FPGA model. The FPGA build result is produced with just one click. In this case, the automatic action takes place in that the subsystems have been accordingly designated in advance, such that the pre-scaling subsystem and the post-scaling subsystem can be identified.

The processor code is generated in particular when the above-mentioned consistency rules have been adhered to. For each individual scaling subsystem, a scaling processor code is first generated in the modeling program, for example Simulink, by means of a code generator, for example Simulink Coder from MathWorks®. According to an embodiment of the invention, the scaling processor code includes an uncompiled C code or C++ code, or a compiled object code. The C/C++ code has the advantage that both ARM processors and X86 processors can be used with the same FPGA board.

For the code generation, a scaling subsystem is in particular first separated into a new model, and this is configured to “Fixed-step” and “Ensure sample time independent”. As a result, the scaling subsystem can be executed later with different task periods. This setting slightly limits the selection of Simulink library blocks; for example, an integrator block cannot be used because it is not sample time independent.

The data interface description is preferably given in XML format. This file, which is named, for example, <scaling_subsystem_name>_datainterfaces.XML, is prepared on the basis of the designation of internal and external interfaces. This determines which ports are used externally as a user interface and which ports communicate internally with the FPGA model. In particular, the data interface description also includes definitions of the parameters, variables, and states. States are variables on which the result of the following step of the simulation depends.

The FPGA code, however, is preferably ready-synthesized, mapped for the specific FPGA, and stored as a configuration bit stream. The advantage of this is that this time-intensive process has already been completed and the user of the FPGA build result does not need to find the time or the FPGA tools to do this. This FPGA bit stream determines the set of functions of the FPGA.

According to an embodiment of the invention, generating the FPGA bit stream comprises the following method steps:
I) generating a code of a predetermined hardware description language, in particular a VHDL code, from the FPGA model,
II) synthesizing a code of the predetermined hardware description language, in particular a VHDL code, from an FPGA user model to obtain a user-model-specific netlist,
III) synthesizing an FPGA framework,
IV) adding the user-model-specific netlist to the synthesized FPGA framework,
V) implementing the FPGA framework comprising the user-model-specific netlist, and generating the FPGA bit stream.

The term “VHDL code”, or a very high-speed integrated circuit hardware description language, also called a VHSIC hardware description language, describes code in a hardware description language and is known to a person skilled in the art as a hardware description language which can be used to describe digital systems in a text-based manner. VHDL has been an IEEE standard since 1987 and optionally also has standardized language extensions.

The hardware description language, such as VHDL or Verilog, can describe the functioning of the FPGA circuit in its entirety in the form of structures and sequences and can prepare the FPGA configuration on that basis. A so-called synthesis tool executes this description like a program and prepares, in a plurality of steps for a desired FPGA, a specific netlist using the resources available in this FPGA.

According to an embodiment of the invention, the master container file comprises metadata, the FPGA bit stream, an interface description for specifying connections of the interfaces, and the sub-containers of the scaling subsystems.

In addition to the FPGA bit stream, an interface description, preferably in XML format, is therefore generated. The interface description, for example named customfunction.xml, specifies which interfaces have been used. To do this, in addition to an FPGA interface block, information is stored as to whether it has a connection (block connection) to a model port block in a scaling subsystem, and if yes, which connection this is. Interface blocks of processor models are preferably understood to be model port blocks.

According to an embodiment of the invention, the use of an FPGA build result prepared using the above-described method is intended for a further application for determining a set of functions of an entire model that includes the FPGA model and the processor model. It is therefore according to an embodiment of the invention, the FPGA build result is not provided directly for executing an HIL simulation. Instead, it is provided to a further application, by which the simulator is configured to execute the entire model. In this case, the entire model includes the FPGA model and the processor model, which can be modeled by the user. Because the scaling subsystems are part of the FPGA build result, a simple and less error-prone interface to the processor model is provided.

The second application can preferably be an intuitive graphical configuration and implementation tool, which is ideal for minor rapid control prototyping (RCP) developments through to large-scale HIL tests on the basis of real-time hardware, including the implementation of behavior models and I/O function code. The master container file of the FPGA build result is supported by the second application.

In this case, during the build of the entire real-time application consisting of the processor model and the overall FPGA functionality, a glue code is additionally generated. In the present case, glue code is understood to be a program code that does not contribute any functions toward achieving the program goals, but merely serves to “stick together” different parts of the program code which would otherwise not be compatible.

This glue code can in particular be automatically generated with information from a <scaling_subsystem>_datainterfaces.XML description file and from the description of the FPGA section (Custom Function.xml) regarding which of the FPGA interfaces are used and whether they reference the interfaces of the scaling subsystems. This glue code invokes the scaling subsystem before the task for all the input ports together, and after the completed task for all the output ports together.

Parameters, variables, and states of the scaling subsystem are applied in the init phase as multi-instance-capable variables, and said scaling subsystem is invoked in a high-performance manner by way of pointers to the data structures in order to avoid a copy operation. Preferably, both the description of the FPGA section (Custom Function.xml) regarding which of the FPGA interfaces are used and the scaling subsystems are multi-instance-capable.

Furthermore, it is preferably provided that init values are specified for each of the data ports visible in the second application. In the init phase of the simulator, this is written to the processor model or to the scaling subsystem.

Once the glue code has been generated, all the code sections of the real-time application are compiled so that they can then be loaded into and executed on an HIL simulator.

According to embodiments of the invention, an FPGA model is also provided, having at least one overall FPGA functionality for an entire model that includes the FPGA model and a processor model, for determining a set of functions of the entire model, the overall FPGA functionality comprising:
an FPGA subsystem, comprising a plurality of logic cells, for determining the FPGA function,
a pre-scaling subsystem for pre-processing at least one data signal provided by the processor model for the FPGA subsystem, and
a post-scaling subsystem for pre-processing at least one data signal provided by the FPGA subsystem for the processor model.

The FPGA functions are ensured by the FPGA subsystem. The FPGA subsystem comprises the internal logic cells. The configurable logic blocks (CLBs) are interconnected by switch boxes. The external connection is implemented by I/O pins. When there is a plurality of overall FPGA functionalities, each overall functionality comprises an FPGA subsystem, a pre-scaling subsystem, and a post-scaling subsystem.

In the present case, scaling means pre-processing. The pre-processing can in particular include operator modeling, offset corrections, and/or data type conversions.

In some embodiments of the invention the entire overall functionality, including the pre-scaling subsystem and the post-scaling subsystem, can be modeled and packetized in the FPGA model.

This provides a number of advantages: First of all, it ensures the modeling of complex functions from various domains, such as FPGA, processor, etc., which give a single FPGA build result that is consistent within itself. In some embodiments, the FPGA model according to the invention makes it possible for the FPGA sections and processor sections of the first application, such as Simulink, to be compatible with and represented in a simplified manner in the further-processing second application for configuration and implementation of the entire model, and thus makes it possible to avoid any user errors. It also allows the external interface to remain stable in the further-processing second application despite internal changes in the interaction of the various domains (FPGA, processor, etc.) modeled in a first application.

The entire model comprising the FPGA model, including the scaling subsystems, as well as the optional processor model is in particular configured in Simulink in a preferably integrated manner for offline simulation.

In some embodiments, the present invention provides a nonvolatile computer-readable storage medium having commands stored thereon which, when executed on a processor, trigger a method as described above.

The above-described method, FPGA model, and/or the use of the FPGA build result are likewise transferable to other systems. The principle is in particular transferable to systems on chips (SoCs) instead of simple FPGAs, GPU boards, DSP boards, AI boards, etc. In addition, the principle is transferable to complex I/O functions.

Instead of communicating internally with an FPGA board via a processor bus, a scaling model running on the processor can also communicate with a standard I/O board. This standard set of I/O functions, for example pulse width modulation (PWM), Wavetable Out, etc., can originate from a fixed firmware version but is parameterizable, or even completely reconfigurable, for example. In other words, pre-scaling subsystems and post-scaling subsystems can be combined with any other type in order thus to generate, from simple I/O functions in combination with pre-scaling models and post-scaling models, a build result which provides a complex I/O function that can be further processed by a second application, in particular configuration and implementation software.

According to embodiments of the invention, a method is further provided for operating a simulation system for testing an object under test, the simulation system comprising a real-time computer, an FPGA, and an operator computer, wherein the real-time computer simulates a processor model and the FPGA simulates an FPGA model as described above, prepared in accordance with the method as described above.

In the following, the invention will be explained in greater detail on the basis of a preferred exemplary embodiment with reference to the drawings, in which:

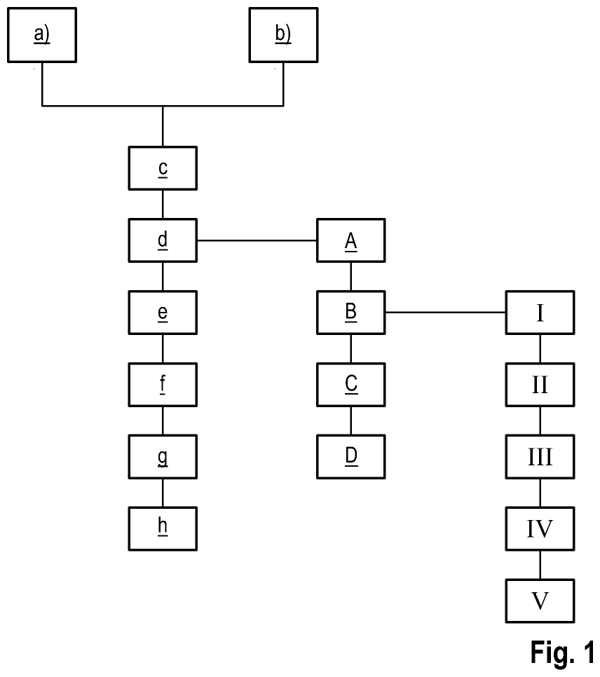

FIG. 1 schematically shows a method for preparing and providing an FPGA build result according to an exemplary embodiment of the invention. First, in steps a) and b), the FPGA subsystem 5, the pre-scaling subsystem 6, and the post-scaling subsystem 7 are designated. The FPGA subsystem 5 determines the actual set of FPGA functions of the FPGA model 1. The scaling subsystems 6, 7 can pre-process the data signals received from the processor model 3 or sent to the processor model 3.

Then, in step c), the internal and external interfaces are designated in the scaling subsystems 6, 7. The internal interfaces ensure a data flow within the FPGA model 1 toward or away from the FPGA subsystem 5, and the external interfaces ensure a data flow away from the FPGA model toward the processor model 3, or vice versa.

Proceeding from the designations in steps a), b), and c), the overall FPGA functionality 2 is generated in a subsequent step d). To do this, first in step A, a consistency check of the designated scaling subsystems 6, 7 is performed in order to avoid errors in the modeling. After this, in step B, the FPGA bit stream is generated for the FPGA subsystem 5 or all the FPGA subsystems present in the FPGA model 1. The FPGA bit stream is generated by means of steps I to V. To do this, a VHDL code is generated from the FPGA model 1 and a code is synthesized from the specific FPGA user model such that a user-specific netlist is provided. Then, the FPGA framework is synthesized and the user-specific netlist is added to the FPGA framework. Lastly, the FPGA framework is implemented and the FPGA bit stream is generated therefrom.

Once the FPGA bit stream has been generated, in step C, a scaling processor code is generated for each scaling subsystem 6, 7 and included D, e as sub-container files in a master container file of the FPGA build result, just like the FPGA bit stream. The FPGA build result therefore consists of a single master container file and contains data relating both to the FPGA subsystem 5 and to the scaling subsystems 6, 7.

Then, in step f, the FPGA build result is provided to a further application. By means of this further application, the set of functions of the entire model 4 consisting of the FPGA model 1 and the processor model 3 are configured and implemented for an HIL simulation.

For the HIL simulation, a glue code is generated in step g. In step h, the code sections are compiled, loaded into an HIL simulator, and executed on the HIL simulator.

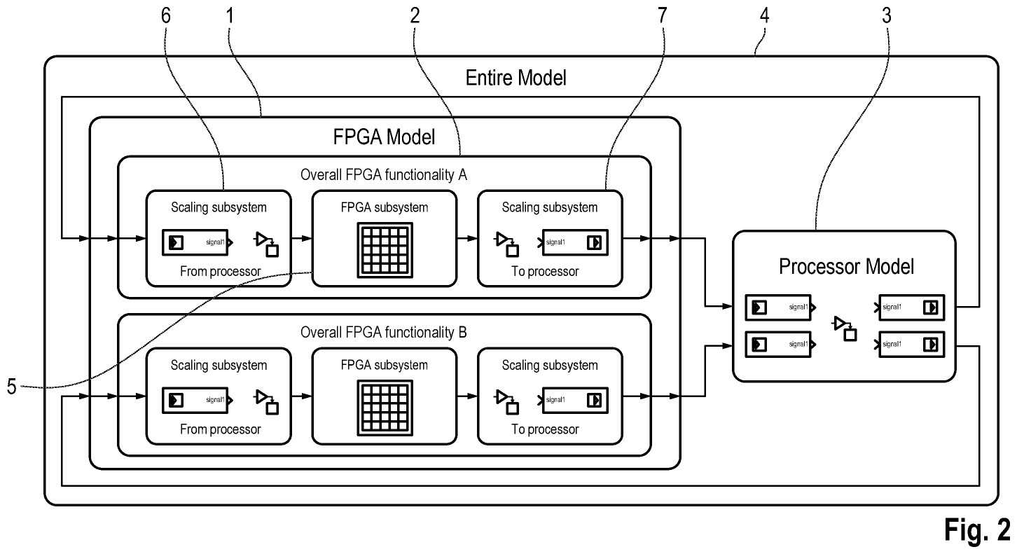

FIG. 2 shows an FPGA model 1 according to an exemplary embodiment of the invention. The entire model 4 includes the FPGA model 1 (on the left) and optionally a processor model 3 (on the right). Prior to the invention, an FPGA pre-scaling and post-scaling system had to be implemented in this processor model, and the corresponding processor model sections had to be copied from the processor model and inserted into or replaced in all the user models that used the FPGA board. Using the FPGA pre-scaling and post-scaling system, these processor sections can now be modeled within the FPGA model 5 as a so-called pre-scaling subsystem 6 and post-scaling subsystem 7. By way of example, FIG. 2 shows two overall FPGA functionalities 2 A and B having the new optional scaling subsystems 6, 7.

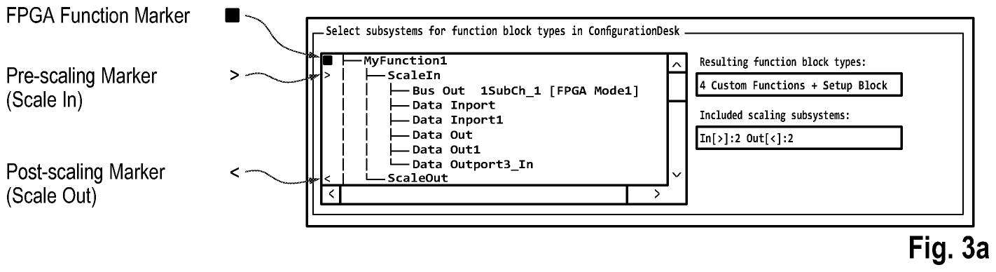

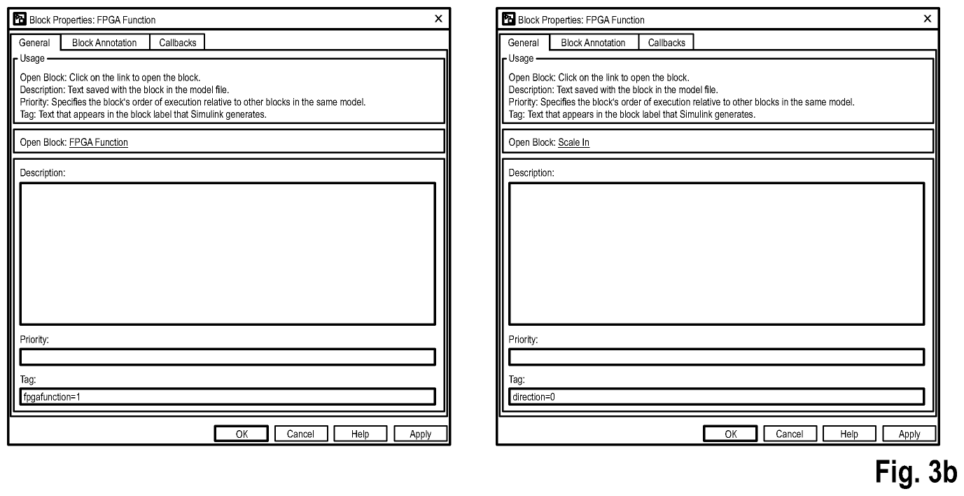

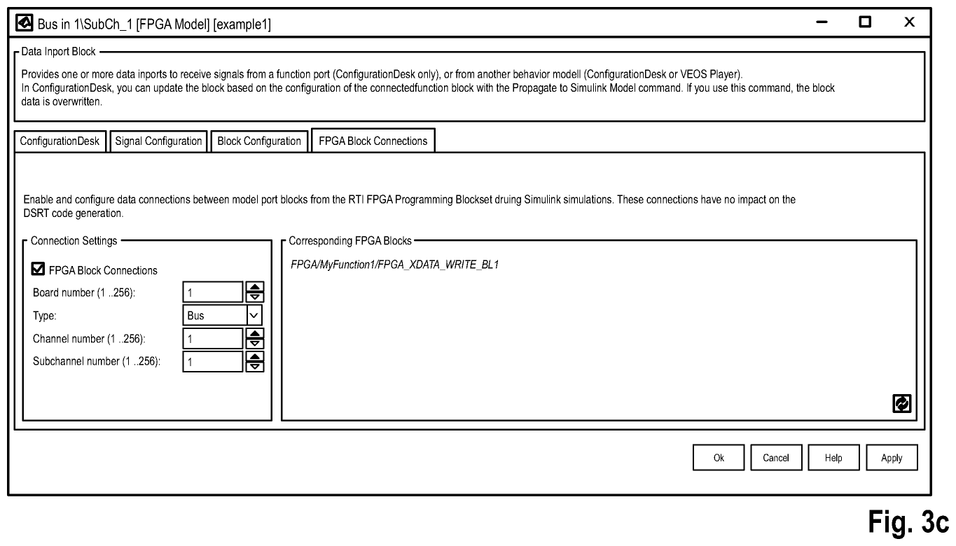

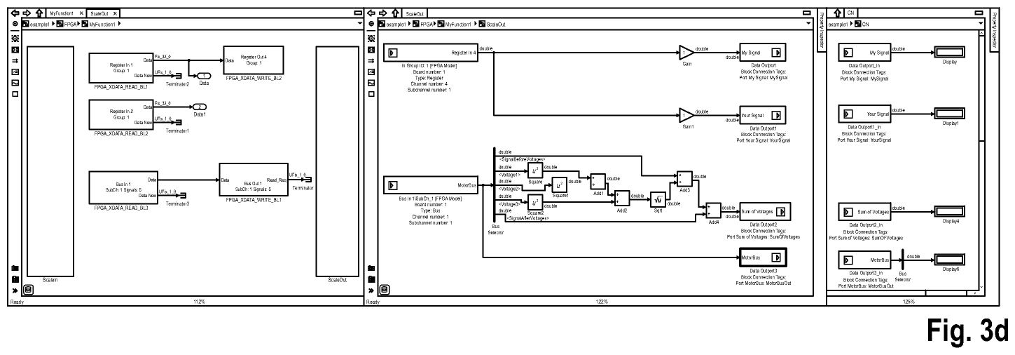

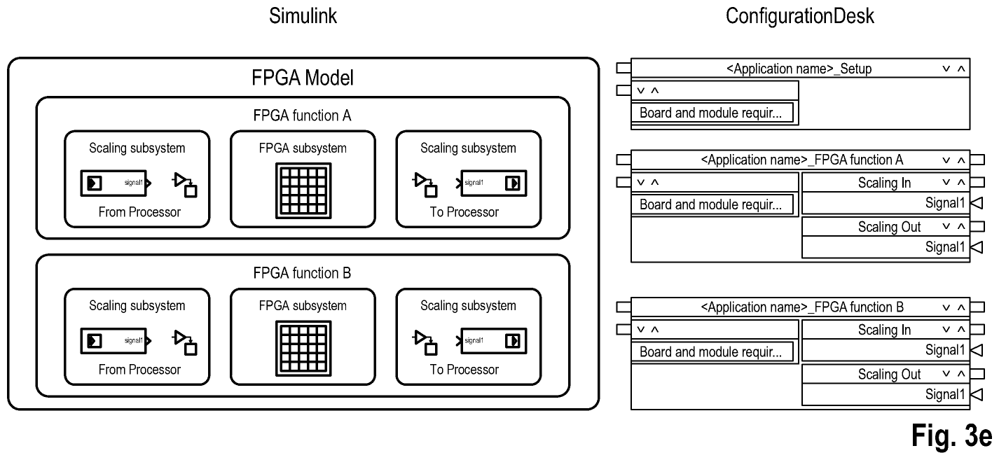

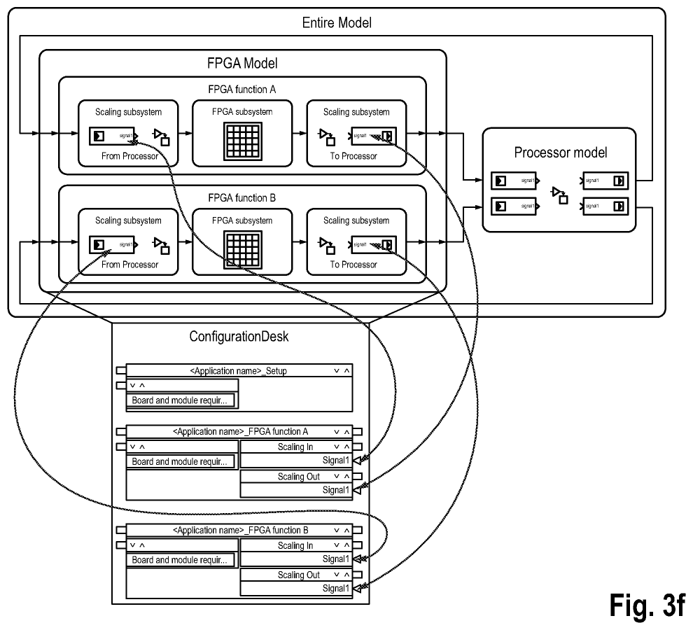

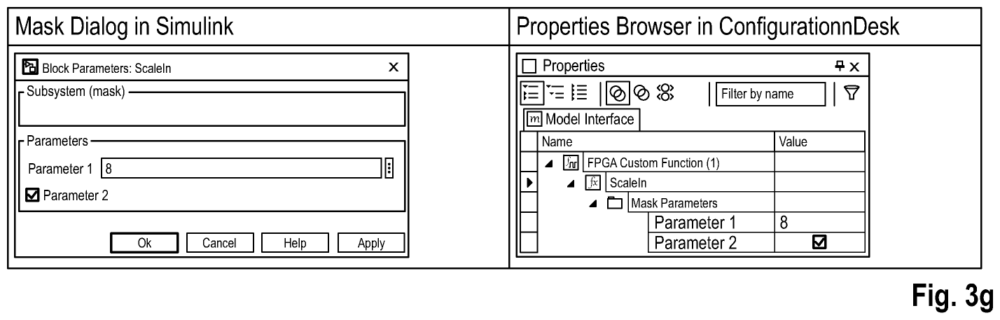

FIGS. 3a to 3g show a specific example application and the visualization of the method as part of a configuration program. A program from dSPACE is used as the configuration program, for example.

To implement the modeling approach, the user can designate both FPGA functions or the FPGA subsystem 5 (cf. FIG. 2) and scaling subsystems 6, 7 (cf. FIG. 2) for pre-scaling and post-scaling. This is done either in a GUI-assisted manner, for example by means of markers, as shown in FIG. 3a, with the subsystems 6, 7 being accordingly internally designated, or manually, as shown in FIG. 3b.

The scaling subsystems 6, 7 have both internal interfaces for a data flow within the FPGA model 1 between the scaling subsystems 6, 7 and the FPGA subsystem 5, and external interfaces for a data flow from the FPGA model 1 toward the processor model 3. These need to be designated accordingly. Since the scaling subsystems 6, 7 are processor models, the dSPACE model port blocks are used for interfaces. The direction toward the FPGA is designated by configuring the corresponding dSPACE FPGA programming blockset interfaces block as an “FPGA block connection” in the model port block, as shown in FIG. 3c. In the example, the corresponding FPGA internal block has the board number 1, is of the bus interface type, and uses subchannel 1 of channel 1. Even though it is not shown here, a scaling subsystem 6, 7 can in principle also contain interfaces that do not correspond to the data flow direction, for instance an interface toward the processor in the pre-scaling subsystem 6. However, they are then not executed in the right order before or after the task, because the scaling subsystem is executed before the processor task during the transfer from FPGA to processor and is executed after the processor task during the transfer from processor to FPGA.

By way of example, FIG. 3d shows the data flow for the direction from FPGA to processor. In the FPGA function “MyFunction1,” results of the FPGA section (on the left) are written to the FPGA interface blocks Register Out 4 and Bus Out 1. In the “ScaleOut” scaling subsystem (in the center), the data are received from the FPGA section by two interface blocks, the block connections of which have been configured to the two FPGA output interfaces. This can be seen in the visualization of the attributes listed below the blocks, which indicate the board number, channel type, channel number, and subchannel number. The other interfaces form the external interface and will later be the only visible interface in the further-processing second application. The post-processing then takes place in the “ScaleOut” subsystem, in which the calculation of the “Sum of Voltages” represents a typical instance of post-processing. The four external interfaces can be used later by the “CN” processor model (on the right). The “CN” processor model (on the right) is not relevant for the overall FPGA functionality and is not part of the FPGA build result either.

FIGS. 3e and 3f show the reuse of the build result in a second application. The FPGA build result of the FPGA model 1 (on the left) is generated in the first application, Math Works® Simulink, and is provided for the configuration and implementation software dSPACE ConfigurationDesk®. The FPGA container files are supported by dSPACE ConfigurationDesk® and are shown in FIG. 3e (on the right).

The exact mapping of the interface ports of the scaling subsystems from the example FPGA model to the FPGA function of the build result, as ConfigurationDesk® indicates, is marked by arrows in FIG. 3f. It is immediately clear from this figure that only the external interfaces are presented in the further-processing application. The overall FPGA functionality 2 of the individual FPGA functions is thus completely encapsulated. A simple, stable interface toward the user's processor model is provided.

The data ports, called “Signal1” by way of example in all the FPGA functions in the example in FIG. 3e (on the right), can be interfaced to an interface block of a processor model in the further-processing application, such as dSPACE ConfigurationDesk®. All the data ports of a scaling subsystem have to be interfaced to the same task in ConfigurationDesk®, otherwise a check will return a conflict. The connection to a task determines that the scaling subsystem is also executed in this task, before the processor task during the transfer from FPGA to processor and after the processor task during the transfer from processor to FPGA.

FIG. 3g shows that the mask parameters of the scaling subsystems are applied as init values in the build result. These applied parameters are automatically offered by the configuration tool of the real-time application dSPACE ConfigurationDesk® as adjustable configuration parameters. Furthermore, they are offered, via the memory map of the real-time application, to an experiment tool such as dSPACE ControlDesk® or XIL API for manipulation during the runtime.

Since mask parameters can be used as variables by the underlying scaling subsystem processor blocks, the subsystems are thus individually parameterizable.

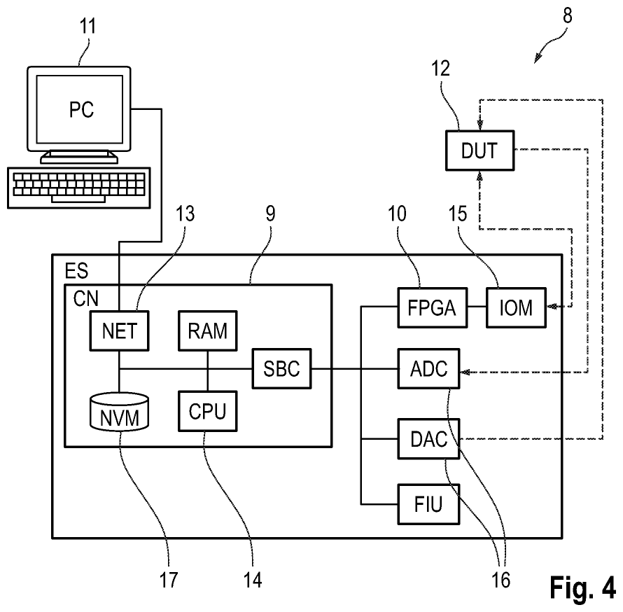

FIG. 4 shows a simulation system 8 for testing an object under test 12 (or device under test (DUT)). In addition to the object under test 12, the simulation system 8 comprises an operator computer 11 (or personal computer (PC)), a real-time computer 9 (or computing node (CN)), and an FPGA 10. The object under test 12 can be a controller to be tested, for example.

Using the operator computer 11, the processor model is modeled and initialized on the processor, and the FPGA application is downloaded. The operator computer 11 is connected to the real-time computer 9 via a network module 13 (or network (NET)).

The real-time processor 14 (or control processing unit (CPU)) of the real-time computer 9 executes the processor application. The appropriate commands are stored on the nonvolatile storage medium 17 (or nonvolatile memory (NVM)) of the real-time computer 9. The real-time processor 14 initiates the transmission and receipt of data to and from the FPGA 10 via a board-specific bus. The real-time processor 14 can also be interfaced to its own I/O channels in order to provide a set of I/O functions independently of the FPGA 10.

The FPGA 10 processes the FPGA application (FPGA logic implementation). The FPGA 10 is connected to its own I/O channels 15 (or input-output module (IOM)) in order to process I/O signals independently of the real-time processor 14. When the real-time processor 14 initiates the data exchange, the FPGA 10 transmits data to and receives data from a board-specific bus.

In order to enable access to the external I/O signals of the object under test 12, the signals have to be converted such that they meet the requirements of the interfaced components. By way of example, this takes place by means of filters, signal amplifiers, or analog-digital converters 16 (or analog-to-digital converter (ADC) / digital-to-analog converter (DAC)).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 FPGA model
2 Overall FPGA functionality
3 Processor model
4 Entire model
5 FPGA subsystem
6 Pre-scaling subsystem
7 Post-scaling subsystem
8 Simulation system
9 Real-time computer
10 FPGA
11 Operator computer
12 Object under test
13 Network module
14 Real-time processor
15 Input/output module
16 Converter
17 Nonvolatile storage medium

1. A method for preparing and providing a field programmable gate array (FPGA) build result of an FPGA model having at least one overall FPGA functionality, wherein the at least one overall FPGA functionality comprises an FPGA subsystem, a pre-scaling subsystem, and a post-scaling subsystem, the method comprising:
a) designating the FPGA subsystem, wherein a set of FPGA functions of the FPGA model are configurable using the FPGA subsystem,
b) designating the pre-scaling subsystem and the post-scaling subsystem of the FPGA model for execution on a processor,
c) designating internal and external interfaces in the pre-scaling subsystem and post-scaling subsystem, wherein the internal interfaces ensure a first data flow within the FPGA model, and the external interfaces ensure a second data flow away from the FPGA model,
d) generating the at least one overall FPGA functionality,
e) generating the FPGA build result on the basis of the generated at least one overall FPGA functionality, wherein the FPGA build result comprises a single master container file, and
f) providing the FPGA build result to a further application for determining a set of functions of an entire model that comprises the FPGA model and a processor model.

2. The method according to claim 1, wherein generating the at least one overall FPGA functionality comprises:
a) performing at least one consistency check of the pre-scaling subsystem and the post-scaling subsystem.

3. The method according to claim 1, wherein generating the at least one overall FPGA functionality comprises:
b) generating an FPGA bit stream for the FPGA subsystem,
c) generating one scaling processor code per scaling subsystem, and
d) including the FPGA bit stream and the scaling processor codes as a sub-container file in each case in the master container file of the FPGA build result.

4. The method according to claim 3, wherein the sub-container file of the pre-scaling subsystem or the post-scaling subsystem comprises the scaling processor code, a data interface description, and/or makefiles.

5. The method according to claim 4, wherein the scaling processor code comprises a C code, a C++ code, or a compiled object code.

6. The method according to claim 3, wherein generating the FPGA bit stream comprises:
I) generating a code of a predetermined hardware description language from the FPGA model,
II) synthesizing a code of the predetermined hardware description language from an FPGA user model to obtain a user-model-specific netlist,
III) synthesizing an FPGA framework,
IV) adding the user-model-specific netlist to the synthesized FPGA framework, and
V) implementing the FPGA framework comprising the user-model-specific netlist, and generating the FPGA bit stream.

7. The method according to claim 1, wherein the master container file comprises metadata, the FPGA bit stream, an interface description for specifying connections of the interfaces, and sub-containers of the pre-scaling and post-scaling subsystems.

8. A method for using the FPGA build result prepared according to the method of claim 1, the method comprising:
for a further application, using the FPGA build result to determine a set of functions of an entire model that comprises the FPGA model and the processor model.

9. An FPGA model having at least one overall FPGA functionality for an entire model that comprises the FPGA model and a processor model, for determining a set of functions of the entire model, the at least one overall FPGA functionality comprising:
an FPGA subsystem, comprising a plurality of logic cells, for determining FPGA function,
a pre-scaling subsystem for pre-processing at least one data signal provided by the processor model for the FPGA subsystem, and
a post-scaling subsystem for pre-processing at least one data signal provided by the FPGA subsystem for the processor model.

10. A non-transitory computer-readable storage medium having commands stored thereon which, when executed on a processor, trigger a method according to claim 1.

11. A method for operating a simulation system for testing an object under test, the simulation system comprising a real-time computer, an FPGA, and an operator computer, the method comprising:
the real-time computer simulating a processor model; and
the FPGA simulating an FPGA model configured according to claim 9.

12. The method for operating a simulation system for testing an object under test, the simulation system comprising a real-time computer, an FPGA, and an operator computer, wherein the real-time computer simulates a processor model and the FPGA simulates an FPGA model prepared according to claim 1.

13. The method of claim 6, wherein the predetermined hardware description language is Verilog or very high speed hardware description language (VHDL).
